(19) United States
(12) Patent Application Publication
(10) Pub. No.: US 2009/0139988 A1
(43) Pub. Date: Jun. 4, 2009

(54) SYSTEM FOR CREATING MORE UNIFORM DISTRIBUTION OF MICROWAVE ENERGY IN A CAVITY

(76) Inventor: Warren M. Farnworth, Nampa, ID (US)

Correspondence Address: WELLS ST. JOHN P.S., 601 W. FIRST AVENUE, SUITE 1300, SPOKANE, WA, 99201, US

(21) Appl. No.: 11/949,539

(22) Filed: Dec. 3, 2007

(51) Int. Cl. H05B 6/74; H05B 6/64

(52) U.S. Cl. 219/750; 219/756

(57) ABSTRACT

A microwave device is disclosed which includes a cavity wherein varied frequency microwaves are generated, a movable tuning member that is adapted to extend into the cavity and a force generator that is mechanically coupled to the movable tuning member, the force generator, when actuated, being adapted to move the movable tuning member within an opening in the cavity. A method is also disclosed which includes varying a volume of a cavity in a microwave generator and generating varied frequency microwaves in the cavity.

### BACKGROUND

1. Technical Field

The present subject matter is generally directed to the field of microwave devices and their operation, and, more particularly, to a system for creating more uniform distribution of microwave energy in a cavity.

2. Description of the Related Art

Microwave devices, such as microwave ovens and microwave heating devices, have been in existence for some time. In these devices, microwave power is introduced into a microwave cavity from a microwave generator, either directly or through one or more wave guides permanently affixed to and interfacing with the side, top or bottom walls of the cavity. Due to the nature of the microwave radiation and the configuration of the microwave cavity, introduction of the microwave power from a fixed source produces fixed standing wave patterns of power distribution. This results in non-uniform distribution of microwave power within the cavity producing localized areas of high and low power. This non-uniform power produces relative hot and cold areas and non-uniform heating of the object in the cavity, e.g., food, integrated circuit devices, etc.

In an attempt to overcome this problem and provide a uniform distribution of microwave power within a microwave cavity, so-called mode-stirrers have been used. In some cases, blades mounted on a sleeve surrounding an antenna are continuously rotated within the cavity to change the microwave standing wave pattern. Other examples include rotating blades, a rotating plate, rotating slotted discs or rotating cylinders. None of these devices have proven to be entirely successful in providing uniform distribution of microwave energy within the microwave cavity.

The present subject matter is directed to a device and various methods that may solve, or at least reduce, some or all of the aforementioned problems.

### BRIEF DESCRIPTION OF THE DRAWINGS

The subject matter disclosed herein may be understood by reference to the following description taken in conjunction with the accompanying drawings, in which like reference numerals identify like elements, and in which:

FIG. 1 schematically depicts an illustrative embodiment of a system for more uniformly distributing microwave energy in a cavity;

FIG. 2 depicts various cross-sectional configurations of the illustrating tuning member described herein;

FIG. 3 depicts an illustrative embodiment of the tuning member wherein the cross-sectional area of the tuning member varies along at least a portion of its length;

FIG. 4 depicts another illustrative system for more uniformly distributing microwave energy in a cavity;

FIG. 5 depicts yet another illustrative embodiment of a system for more uniformly distributing microwave energy in a cavity; and

FIG. 6 depicts an additional illustrative embodiment of a system for more uniformly distributing microwave energy in a cavity

While the subject matter described herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Although various regions and structures shown in the drawings are depicted as having very precise, sharp configurations and profiles, those skilled in the art recognize that, in reality, these regions and structures are not as precise as indicated in the drawings. Additionally, the relative sizes of the various features and doped regions depicted in the drawings may be exaggerated or reduced as compared to the size of those features or regions on fabricated devices. Nevertheless, the attached drawings are included to describe and explain illustrative examples of the subject matter disclosed herein.

FIG. 1 schematically depicts an illustrative embodiment of a system 10 for more uniformly distributing microwave energy within a cavity. In general, the system comprises a motor 12, a cavity 14 and a tuning member 16 that is operatively coupled to the motor 12 via a mechanical linkage 20. The cavity 14 is formed within a housing 15. In the depicted embodiment, the tuning member 16 extends through an opening 18 formed in the cavity 14. The end 16A of the tuning member 16 may project into the cavity 14 by a distance 19, which may vary depending upon the particular application, as described more fully below.

After a complete reading of the present application, those skilled in the art will appreciate that the motor 12 may be any kind of force generator, e.g., an electric motor, a pneumatic motor, a hydraulic motor, a piezoelectric motor or actuator, a dual-action cylinder (hydraulic or pneumatic). For ease of reference, the application will generally refer to the force generator as a motor, although the present subject matter is clearly not limited to usages involving only motors. In the depicted example, the motor 12 comprises a drive shaft 12A and a wheel or member 12B that is operatively coupled to the drive shaft 12A. In the illustrative example shown in FIG. 1, the mechanical linkage 20 comprises a bar or rod 22 that is pinned or pivotably coupled to the member 12B and the tuning member 16 via illustrative pinned connections 24 and 26, respectively.

In general, as the drive shaft 12A of the motor 12 rotates, the tuning member 16 will move or reciprocate within the opening 18. The maximum and minimum penetration of the end 16A of the tuning member 16 into the cavity 14 will vary depending upon the particular application. The motor 12 may be any type of motor that is capable of performing the functions described herein. For example, the motor 12 may be an electric, pneumatic or hydraulic motor. The power rating of the motor may also vary depending on the particular application. However, in many applications, it is anticipated that the power rating of the motor 12 will be very small due, in part, to the physical size of the devices used to generate microwaves and the physical size of the tuning member 16.

The system 10 described herein may be employed in connection with any type of device that is employed to generate microwaves. For example, the present subject matter may be employed with devices generally known as magnetrons. Additionally, the subject matter disclosed herein may be employed in a variety of different applications. For example, the subject matter disclosed herein may be employed in devices that are intended for heating food, e.g., home microwave ovens. As another example, the present subject matter may be employed with devices that are used to heat various industrial or commercial objects, e.g., semiconductor wafers or integrated circuit devices. Thus, the present disclosure should not be considered as limited to any particular use of microwave energy or to any particular type of device for generating microwave energy.

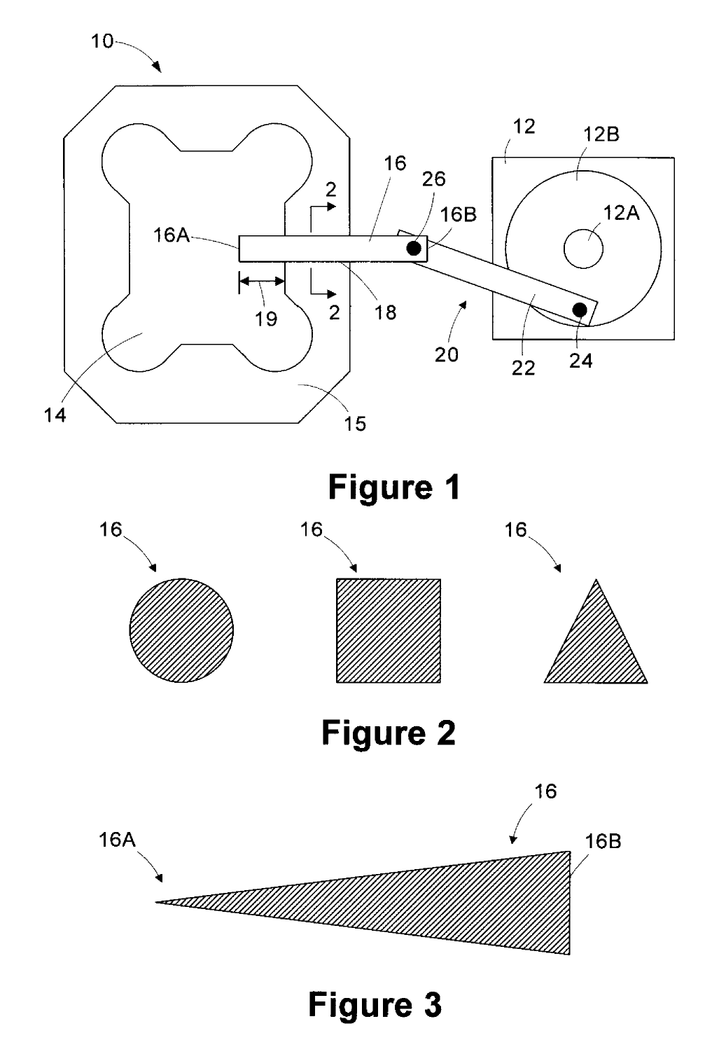

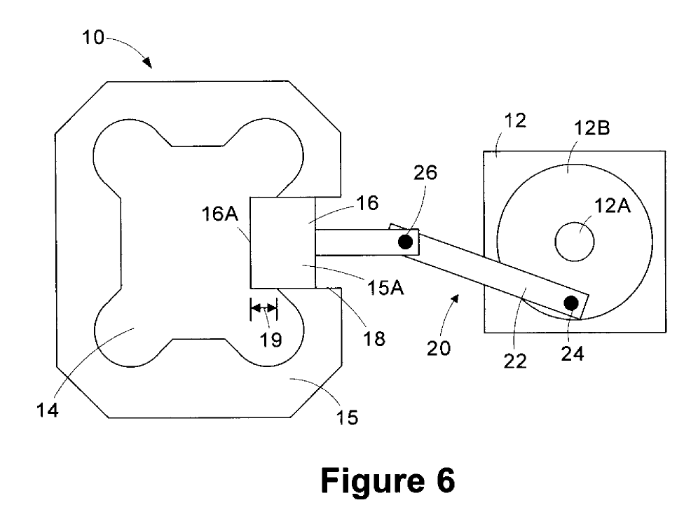

The tuning member 16 may be made of any type of material sufficient to permit it to be used to perform the tuning activities described herein. In general, the tuning member 16 is used to vary the volume of the cavity 14, i.e., decrease or increase the volume, thereby changing the frequency of the microwaves generated within the cavity 14. That is, by varying the volume of the cavity 14, the device 10 generates microwaves having varied frequencies. In general, as the volume of the cavity 14 decreases, the frequency of the microwaves generated in the cavity 14 will increase. Conversely, as the volume of the cavity 14 increases, the frequency of the microwaves generated in the cavity 14 will decrease. In one illustrative example, the tuning member 16 is comprised of a conductive member, such as a metal. When a conductive material is employed, the tuning member 16 acts to reflect microwaves within the cavity 14. The size and configuration of the tuning member 16 may also vary depending upon the particular application. For example, the tuning member 16 may have a substantially circular, rectangular or triangular cross-sectional configuration as depicted from left-to-right, respectively, in FIG. 2. The cross-section of the tuning member 16 may be constant along its length, or the cross-sectional of the tuning member 16 may vary along at least a portion of its length. For example, FIG. 3 depicts an illustrative example wherein the tuning member 16 has a substantially wedge-shaped, lengthwise, cross-sectional configuration. Other configurations of the tuning member 16 are also possible, e.g., the tuning member 16 may have the overall shape of a cone. As described more fully below with reference to FIG. 6, the tuning member 16 may be a portion of the housing 15 that defines the cavity 14.

The opening 18 in the cavity 14 is sized such that the tuning member 16 can move freely within the opening 18. A seal between the tuning member 16 and the opening 18 may or may not be employed. However, the clearance or gap between the opening 18 and the tuning member 16 should be small enough such that the microwaves generated within the cavity 14 do not pass through the clearance or gap.

The illustrative mechanical linkage 20 is provided by way of example only. The bar 22 that is pinned to both the wheel 12B and the tuning member 16 permits the tuning member 16 to reciprocate within the opening 18 as the drive shaft 12A of the motor 12 rotates. By adjusting the length of the bar 22, the amount of penetration 19 of the tuning member 16 into the cavity 14 may be controlled. Additionally, by varying the speed of rotation of the motor 12, the time that microwaves of a particular frequency are generated in the cavity 14 may be varied or controlled. For example, all other things being equal, the greater the frequency with which the tuning member 16 penetrates the cavity 14, i.e., changes the volume of the cavity 14, the shorter will be the time that microwaves of a particular frequency are generated in the cavity 14. Conversely, reducing the frequency with which the tuning member 16 penetrates the cavity 14, increases the time at which microwaves of a particular frequency are generated in the cavity 14.

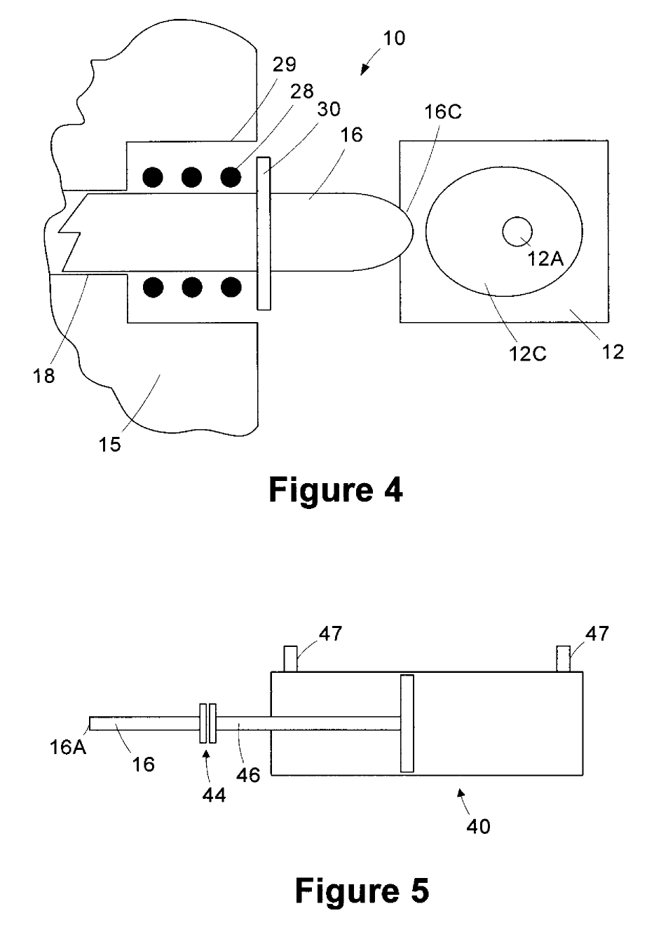

A portion of another system 10 that may be employed as described herein is schematically depicted in FIG. 4. As shown therein, the tuning member 16 may be moved by engagement of one or more cammed surfaces. More specifically, a cammed wheel 12C is operatively coupled to the illustrative motor 12. The end 16C of the tuning member 16 is rounded such that it may engage the surfaces on the cammed wheel 12C as the wheel 12C rotates. In this example, the tuning member 16 is provided with a flange 30 that engages a return spring 28 positioned in a recess 29 formed in the housing 15. As the wheel 12C rotates, the tuning member 16 reciprocates in the opening 18 due to the interaction between the end 18C and the surfaces on the wheel 12C.

FIG. 5 depicts yet another illustrative system 10 that may be employed as described herein. More specifically, the tuning member 16 is operatively coupled to a dual-action cylinder 40 with inlets/outlets 47. The cylinder 40 may be either a hydraulic or pneumatic cylinder. The structure and function of such a dual-action cylinder is well known to those skilled in the art. Thus, the details of such dual-action cylinders will not be presented in detail so as not to obscure the present disclosure. In general, the cylinder 40 will be operatively coupled to a source of hydraulic or pneumatic power, e.g., pressurized liquid or air. The cylinder 40 will comprise associated lines and valving that is operatively coupled to the cylinder 40 so as to permit the cylinder 40, when actuated, to cause the tuning member 16 to reciprocate within the opening 18. In the illustrative example depicted in FIG. 5, the tuning member 16 is operatively coupled to the piston rod 46 of the cylinder 40 by a schematically-depicted bolted flanged connection 44.

FIG. 6 depicts an illustrative example wherein the tuning member 16 is actually a portion of the housing 15 that defines the cavity 14. In this example, the housing portion 15A, e.g., all or a portion of a wall of the cavity 14, is operatively coupled to the illustrative mechanical linkage system depicted in FIG. 1. Of course, those skilled in the art will readily appreciate that the other systems disclosed herein may be employed to move the housing portion 15A. For example, the cylinder 40 shown in FIG. 5 could be operatively coupled to the housing portion 15A to thereby cause the desired change in volume of the cavity 14.

As disclosed above, the present subject matter may be employed to generate microwaves of varied frequencies. Such microwaves of varied frequencies tend to make the distribution of the microwaves more uniform as compared to prior art devices wherein the microwave generators produced microwaves having a fixed frequency. In practice, the use of varied frequency microwaves to heat an object, e.g., food, an integrated circuit device, etc., should tend to reduce localized hot or cold (in a relative sense) spots during the heating of the object.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A microwave device, comprising:
a cavity wherein microwaves are generated;
a movable tuning member positioned in an opening in the cavity, the movable tuning member being adapted to be extended into the cavity; and
a force generator that is mechanically coupled to the movable tuning member, the force generator, when actuated, being adapted to cause the movable tuning member to move within the opening in the cavity.

2. The device of claim 1, wherein the movable tuning member is mechanically coupled to the force generator such that, when the force generator is actuated, the movable tuning member reciprocates within the opening in the cavity.

3. The device of claim 2, wherein the force generator is an electric motor, a pneumatic motor, a hydraulic motor, a piezoelectric motor, a pneumatic piston or a hydraulic piston.

4. The device of claim 2, wherein the force generator is a motor that is mechanically coupled to the movable tuning member by a mechanical linkage comprising at least two pivotable connections.

5. The device of claim 4, wherein the mechanical linkage comprises a bar that is pivotably coupled to the movable tuning member and pivotably coupled to a wheel that is operatively coupled to the motor.

6. The device of claim 1, wherein the force generator is a dual-action piston that is operatively coupled to the movable tuning member.

7. The device of claim 1, wherein the movable tuning member is a bar of conductive material.

8. The device of claim 1, wherein the movable tuning member is a portion of a housing that at least partially defines the cavity.

9. A microwave device, comprising:
a cavity wherein microwaves are generated;
a movable tuning member positioned in an opening in the cavity, the movable tuning member being adapted to be moved to thereby change a volume of the cavity; and
a motor that is mechanically coupled to the movable tuning member, the motor, when actuated, being adapted to move the movable tuning member within the opening in the cavity.

10. The device of claim 9, wherein the movable tuning member is mechanically coupled to the motor such that, when the motor is actuated, the movable tuning member reciprocates within the opening in the cavity.

11. The device of claim 10, wherein the motor is an electric motor, a pneumatic motor, a piezoelectric motor or a hydraulic motor.

12. The device of claim 10, wherein the motor is mechanically coupled to the movable tuning member by a mechanical linkage comprising at least two pivotable connections.

13. The device of claim 10, wherein the mechanical linkage comprises a bar that is pivotably coupled to the movable tuning member and pivotably coupled to a member that is operatively coupled to the motor.

14. A microwave device, comprising:
a cavity wherein microwaves are generated; and
means for changing a volume of the cavity while microwaves are generated in the cavity.

15. The device of claim 14, wherein the means for changing the volume in the cavity comprises a movable tuning member and a force generator that, when actuated, is adapted to move the movable tuning member within an opening in the cavity.

16. The device of claim 15, wherein the movable tuning member is a bar of conductive material.

17. The device of claim 15, wherein the movable tuning member is a portion of a housing that at least partially defines the cavity.

18. A method, comprising:
varying a volume of a cavity in a microwave generator; and
generating varied frequency microwaves in the cavity while the volume of the cavity is being varied.

19. The method of claim 18, wherein varying a volume of the cavity comprises moving at least a portion of a tuning member within an opening in the cavity during a period of time when microwaves are being generated in the cavity so as to vary the volume of the cavity.

20. The method of claim 19, wherein moving at least a portion of the tuning member comprises moving the tuning member such that it reciprocates within the opening.

21. The method of claim 18, wherein the microwave generator is a magnetron.

22. The method of claim 18, further comprising irradiating an object with the varied frequency microwaves.

23. The method of claim 19, wherein moving the tuning member comprises actuating a motor that is mechanically coupled to the movable tuning member.

24. The method of claim 19, wherein moving the tuning member comprises actuating a dual-action cylinder that is mechanically coupled to the movable tuning member.

25. The method of claim 19, wherein moving the tuning member comprises engaging an end of the tuning member with a cammed surface of a component that is operatively coupled to the motor.

26. A method, comprising:
providing a microwave generator having a cavity with an opening in the cavity; and
generating varied frequency microwaves by moving at least a portion of a tuning member within the opening in the cavity during a period of time when microwaves are being generated in the cavity so as to vary a volume of the cavity.

27. The method of claim 26, wherein moving at least a portion of the tuning member comprises moving the tuning member such that it reciprocates within the opening.
